(19) United States
(12) Patent Application Publication
(10) Pub. No.: US 2024/0098451 A1
(43) Pub. Date: Mar. 21, 2024

(54) SYSTEMS AND METHODS FOR DIFFERENTIAL AND NON-DIFFERENTIAL NAVIGATION WITH CELLULAR SIGNALS

(71) Applicant: The Regents of the University of California, Oakland, CA (US)

(72) Inventors: Zak Kassas, Columbus, OH (US); Joe Khalife, Irvine, CA (US)

(21) Appl. No.: 18/548,566

(22) PCT Filed: Mar. 1, 2022
(86) PCT No.: PCT/US2022/018338

§ 371 Date: Aug. 31, 2023

Related U.S. Application Data
(60) Provisional application No. 63/155,048, filed on Mar. 1, 2021.

(51) Int. Cl. H04W 4/024; G01S 5/00; G01S 5/02; H04B 7/26; H04W 4/40

(52) U.S. Cl. CPC H04W 4/024; G01S 5/009; G01S 5/0205; H04B 7/2628; H04W 4/40

(57) ABSTRACT

Processes and device configurations are provided for navigation using communications signal observables and using differential and non-differential frameworks. Communication signals, such as cellular communication signals may be used to obtain position estimates of a device such as a rover or unmanned aerial vehicle. Frameworks are provided for determination of position estimates with and without the use of a base station device. Processes can include use of position estimates to aid navigation.

### CROSS REFERENCE TO RELATED APPLICATION

This application is the National Stage entry under 35 U.S.C. § 371 of International Application No. PCT/US2022/018338, filed Mar. 1, 2022, which claims priority to U.S. provisional application No. 63/155,048 titled SYSTEMS AND METHODS FOR DIFFERENTIAL AND NON-DIFFERENTIAL NAVIGATION WITH CELLULAR SIGNALS filed on Mar. 1, 2021, the content of which is expressly incorporated by reference in its entirety.

### STATEMENT OF GOVERNMENT SUPPORT

This invention was made with Government support under Grant No. N00014-19-1-2305 awarded by the Office of Naval Research, Grant No. 1751205 awarded by the National Science Foundation, and Grant No. 69A3552047138 awarded by the Department of Transportation (USDOT) under the University Transportation Center (UTC) Program. The Government has certain rights in the invention.

### FIELD

The present disclosure generally relates to opportunistic navigation and to differential and non-differential frameworks for navigation with cellular signals, including sub-meter accurate navigation.

### BACKGROUND

There is a need for a resilient, accurate, and tamper-proof navigation system for use by Unmanned Aerial Vehicles (UAVs). Current UAV navigation systems will not meet these stringent demands as they are dependent on global navigation satellite system (GNSS) signals, which are jammable, spoofable, and may not be usable in certain environments (e.g., indoors and deep urban canyons). One challenge that arises in cellular-based navigation is the unknown states of cellular base transceiver stations (BTSs), namely their position and clock errors (bias and drift). This is in sharp contrast to GNSS-based navigation where the states of the satellites are transmitted to the receiver in the navigation message. Conventional approaches can utilize devices that have knowledge of states (e.g., by having access to GNSS signals), while estimating the states of BTSs, and sharing BTS data. Another framework uses positions mapped prior to navigation. However, this approach does not provide accurate operation.

There also exists a desire for submeter-level (centimeter to decimeter) navigation. Convectional approaches have difficulty resolving determinations. These methods may rely multiple-frequency measurements, rely on the GNSS satellite geometry, or rely on dedicated ground-based GPS integrity beacons. These approaches however may not provide reliable resolution of ambiguities and may not guarantee navigation performance requirements.

There is a desire for use of communications signals, such as cellular communication signals to allow for navigation and sub-meter accurate navigation operations.

### BRIEF SUMMARY OF THE EMBODIMENTS

Disclosed and described herein are systems, methods and configurations for controlling navigation using cellular communication signals. In one embodiment, a method includes receiving, by a device, a cellular communication signal including a synchronization element, and determining, by the device, a position estimate for the device using the cellular communication signal. Determining the position estimate includes determining a coarse estimate of device position based on a carrier phase determination using the synchronization element of the cellular communication element, and refining the coarse estimate of device position using a framework to determine the position estimate wherein a weighted nonlinear least squares estimator is applied to a model of device position for a plurality of time intervals. The method also includes controlling, by the device, navigation using the position estimate.

In one embodiment, the communication signal is at least one of a code division multiple access (CDMA) cellular communication signal including a pseudo random noise sequence (PRN) as the synchronization element and a long term evolution (LTE) cellular communication signal including a primary synchronization signal (PSS) or secondary synchronization signal (SSS) as the synchronization element.

In one embodiment, an extended Kalman filter (EKF) operation is performed by the device on the received communication signal to obtain the coarse estimate of device position and by using a vector model of device position and a known position reference.

In one embodiment, refining the coarse estimate includes a double differencing operation to obtain a batch solution to fix at least one integer ambiguity.

In one embodiment, the framework to determine the position estimate is a differential framework that includes using a base station position and a base station carrier phase measurement received from a base station.

In one embodiment, the differential framework determines the position estimate using a batch weighted non-linear least squares estimator to estimate position based on estimated integer ambiguities for a plurality of time intervals.

In one embodiment, the batch weighted non-linear least squares estimator uses a collection of carrier phase measurements from a plurality of time steps, and wherein the batch weighted non-linear least squares estimator is initialized with the coarse estimate of device position.

In one embodiment, an upper bound of position error is determined and utilized by the device to determine the position estimate.

In one embodiment, the framework to determine the position estimate is a non-differential framework that includes using a known position of the device and weighted non-linear least squares estimator to estimate position based on clock cluster biases.

In one embodiment, navigation using the position estimate and at least one of a differential and non-differential framework to determine device position for a plurality of time intervals.

According to another embodiment, a device is provided for controlling navigation using cellular communication signals. The device includes a receiver configured to receive a cellular communication signal, and a controller coupled to the receiver. The controller is configured to receive a cellular communication signal including a synchronization element, and determine a position estimate for the device using the cellular communication signal. Determining the position estimate includes determining a coarse estimate of device position based on a carrier phase determination using the synchronization element of the cellular communication element, and refining the coarse estimate of device position using a framework to determine the position estimate wherein a weighted nonlinear least squares estimator is applied to a model of device position for a plurality of time intervals. The controller also controls navigation using the position estimate.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1A is a graphical representation of navigation according to one or more embodiments;

FIG. 1B is a graphical representation of a system for navigation according to one or more embodiments;

FIG. 2 illustrates a process for acquisition of one or more observables from communications signals according to one or more embodiments;

FIG. 3 depicts a device configuration according to one or more embodiments;

FIG. 4 illustrates a graphical representation of a navigation framework according to one or more embodiments;

FIG. 5A illustrates a graphical representation of a UAV and base transmitter stations according to one or more embodiments;

FIG. 5B illustrates a graphical representation of horizontal dilution of precision according to one or more embodiments;

FIG. 6 illustrates a graphical representation of carrier phase data according to one or more embodiments;

FIG. 7 illustrates a graphical representation of experimental data according to one or more embodiments;

FIG. 8 illustrates base station data according to one or more embodiments;

FIG. 9 illustrates a navigation system and devices according to one or more embodiments;

FIG. 10 illustrates representations of time and position error according to one or more embodiments;

FIG. 11 illustrates another navigation system and configuration according to one or more embodiments;

FIG. 12 illustrates another navigation system and configuration according to one or more embodiments; and

FIG. 13 illustrates another navigation system and configuration according to one or more embodiments.

### DETAILED DESCRIPTION OF THE EXEMPLARY EMBODIMENTS

### Overview and Terminology

Embodiments of the disclosure are directed to navigation using communication signals, and in particular, cellular communication signals. In one embodiment, processes and configurations are provided to use signal parameters and signal structures to allow a device, such as an unmanned aerial vehicle (UAV), to navigate without the use of global positioning data sources. Processes and configurations are also provided to leverage one or more communication signal features and to improve the processing of communication signals. According to one embodiment, processes and configurations are provided to determine a position estimate for the device using at least one of a differential and non-differential frameworks, and to control navigation of a device, such as an unmanned aerial vehicle (UAV), using the position estimate. Device configurations and processes described herein may employ a framework for utilization of

Embodiments describe use of communication signals, such as cellular communication signals. It should be appreciated that operations and frameworks may be applied to signals of opportunity and allow for use with one more wireless communication formats. As such, downlink transmissions may be decoded to determine observables and as an aid in navigation.

Cellular signals, particularly 3G code-division multiple access (CDMA), 4G long-term evolution (LTE), and 5G new radio (NR), are among the most attractive SOP candidates for navigation. These signals are abundant, received at a much higher power than GNSS signals, offer a favorable horizontal geometry, and are free to use. Moreover, high-precision measurements can be obtained when using carrier phase measurements instead of code phase measurements. While meter-level accuracy is achievable with pseudorange measurements, submeter-level (centimeter to decimeter) is achievable in carrier phase differential GNSS (CD-GNSS), also known as real-time kinematic (RTK).

There are several challenges associated with navigation with SOPs, and with carrier phase measurements from cellular signals in particular: (i) the SOP states (position and clocks) are unknown, (ii) in a differential framework, carrier phase ambiguities must be resolved, which in turn induces errors, and (iii) in a non-differential framework, even if the SOP position is known, the clock biases must be continuously estimated, making the system under-determined.

Embodiments of the disclosure present a complete methodology for submeter-accurate UAV navigation using cellular carrier phase measurements. A differential and a non-differential framework are proposed. The differential framework requires a base receiver making carrier phase measurements to the same BTSs as the navigating UAV and assumes a communication channel between the base and UAV receivers. A non-differential, single UAV framework is also proposed in case carrier phase differential (CD)-cellular measurements are unavailable (e.g., communication channel is lost or the base is compromised).

The resulting navigation accuracy from using these frameworks is unprecedented at the submeter-level. This will allow UAVs to navigate safely in GNSS-challenged environments (e.g., urban canyons), which can open up a wide range of applications in such environments, such as package delivery and search and rescue

One embodiment is directed to a device structure and receiver processes. The device may be configured to observables from at least one base transceiver station. System configurations may employ one or more devices to perform receiver operations described herein.

Embodiments described herein provide processes and device configurations for submeter accurate UAV navigation using cellular carrier phase measurements. Embodiments are provided and described herein for differential and a non-differential frameworks. According to embodiments, a differential framework requires a base receiver making carrier phase measurements to the same BTSs as the navigating UAV and assumes a communication channel between the base and UAV receivers. According to embodiments, a non-differential framework can include a single UAV framework is also proposed in case CD-cellular measurements are unavailable (e.g., communication channel is lost or the base is compromised). The non-differential framework does not require a base receiver, it can operate on the assumption that the navigating UAV has knowledge of its position for an initial period of time, e.g., from GNSS or from the CD-cellular framework before loss of communication with the base. In contrast to other non-differential frameworks, embodiments improve upon reliability and provide submeter-accurate UAV navigation.

According to embodiments, processes and configurations described herein can employ a three-stage framework for navigating with CD cellular measurements. A first stage can employ an extended Kalman filter (EKF) to obtain a coarse estimate of a UAV position. In the second stage, a batch solution is obtained to fix the integer ambiguities. In the third stage, the UAV navigates with the CD-cellular measurements and fixed ambiguities.

According to embodiments, processes and configurations improve navigation by determining an upper bound on the position error after resolving the integer ambiguities is established. The upper bound can capture mainly the effect of the integer ambiguity error on the UAV position error. Models of the BTS positions from stochastic geometry are leveraged to determine the upper bound that holds with a desired probability, given the number of BTSs. According to embodiments, upper bound determinations are derived to formulate a test that determines when to solve the batch estimator and fix the integer ambiguities in order to guarantee that the UAV position remains under a pre-defined threshold, with a certain probability.

Experimental results are described demonstrating operation of CD-cellular frameworks and non-differential, single-UAV framework. The experiments show UAVs navigating at submeter-level accuracy with the proposed frameworks. In the CD-cellular framework, the UAV achieves a position root mean-squared error (RMSE) of 63.06 cm over a UAV trajectory of 1.72 km. In the non-differential, single UAV framework, two experiments performed at different times are presented, showing one UAV achieving a position RMSE of 36.61 cm over a trajectory of 1.72 km while the other showing a position RMSE of 88.58 cm over a trajectory of 3.07 km.

According to embodiments, a first framework relies on a base receiver sharing carrier phase measurements with a navigating UAV. The framework is designed to guarantee that after some time, the UAV's position error remains below a pre-defined threshold with a desired probability. For the differential framework, an upper bound on the position error after resolving the integer ambiguities is established. The derived upper bound is used to formulate a test that determines when to solve the batch estimator and fix the integer ambiguities in order to guarantee that the UAV position error remains under a pre-defined threshold, with a certain probability. This is not guaranteed in other existing methods.

According to other embodiments, a second framework leverages the relative stability of cellular base transceiver station (BTS) clocks, which alleviates the need for the base receiver. For the non-differential framework, the carrier phase measurement model is modified to achieve submeter accuracy without the need of a base. This brings the navigation error down an order of magnitude from the state-of-the-art in cellular-based navigation.

Extensive experimental results are presented demonstrating unprecedented accuracies with the CD-cellular frameworks and a single-UAV framework. It is shown through experimental data that the beat frequency stability of cellular BTSs approaches that of atomic standards, which could be exploited for precise navigation with cellular carrier phase measurements. Embodiments may be applied to autonomous systems including but not limited to precise UAV navigation systems with cellular signals is developed as a complement or alternative to GNSS, especially in GNSS-challenged environments.

The experiments show UAVs navigating at submeter-level accuracy with the proposed frameworks. In the CD-cellular framework, the UAV achieves a position root mean-squared error (RMSE) of 63.06 cm over a UAV trajectory of 1.72 km. In the non-differential, single UAV framework, two experiments performed at different times are presented, showing one UAV achieving a position RMSE of 36.61 cm over a trajectory of 1.72 km while the other showing a position RMSE of 88.58 cm over a trajectory of 3.07 km.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

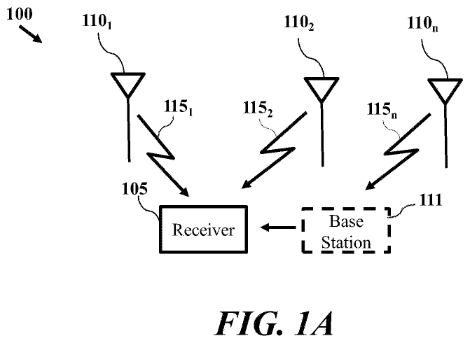

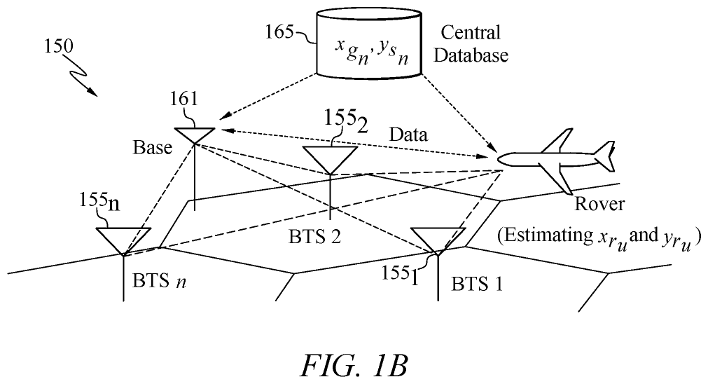

FIG. 1A is a graphical representation of navigation according to one or more embodiments. According to embodiments, configurations are provided for cellular communication network 100. Receiver 105 may be device, such as a UAV, configured to utilize parameters of cellular communication signals of cellular communication network 100. By way of example, cellular communication network 100 includes a plurality of base transceiver stations (BTSs) 110₁₋ₙ, each generating communication signals 115₁₋ₙ. According to embodiments, and as described below, receiver 105 may be configured to determine position and navigate using communication signals 115₁₋ₙ. According to embodiments, receiver 105 and base station 111 may each receive the same communication signals 115₁₋ₙ from the same BTSs 110₁₋ₙ. Base station 111 and its communication with receiver 105 may be optional. Processes and configurations described herein may leverage one or more communication signal features, and characteristics of communication network 100 for navigation, including submeter navigation for a UAV.

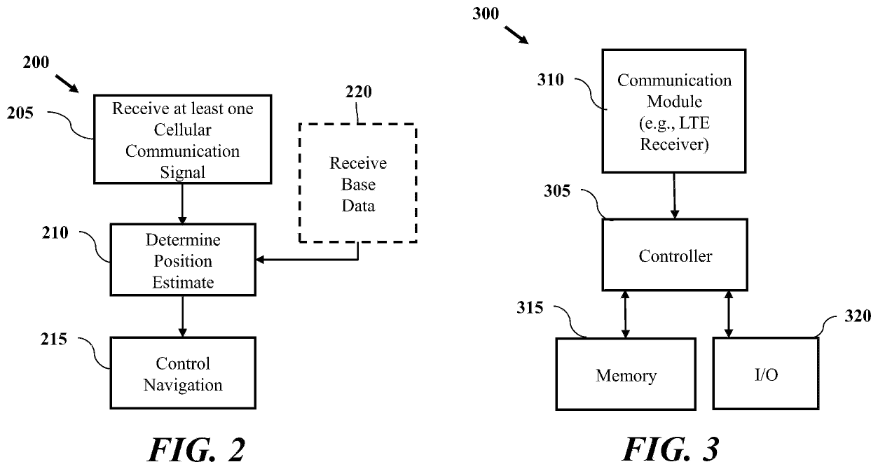

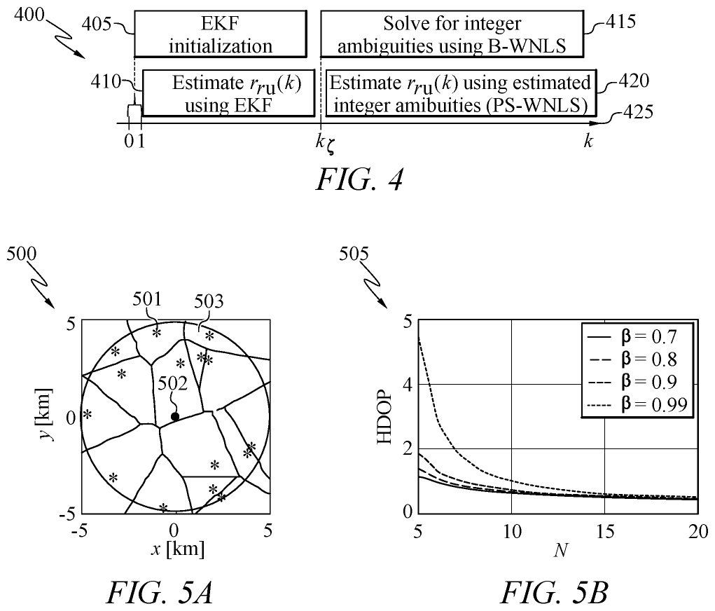

According to embodiments, receiver 105 may be a device configured to utilize one or more frameworks described herein. Receiver 105 may be configured to utilize processes described herein, such as process 200 of FIG. 2 and process 400 of FIG. 4 for navigation. According to embodiments, receiver 105 may be configured to use a differential framework. According to other embodiments, receiver 105 may be configured to use a non-differential framework. Receiver 105 and optional base station 111 may be configured to determine cellular carrier phase determinations based on a carrier phase model. Frameworks as described herein can provide submeter-accurate unmanned aerial vehicle (UAV) navigation with cellular carrier phase measurements are developed.

As used herein, a differential framework can include a base receiver, such as base station 111, sharing carrier phase measurements with a navigating UAV, such as receiver 105. A differential framework as described herein can guarantee that after some time, the UAV's position error remains below a pre-defined threshold with a desired probability. Experimental results are presented showing that this framework can achieve a 63.06 cm position root mean-squared error (RMSE) over a UAV trajectory of 1.72 km. Non-differential frameworks as described herein can leverage relative stability of cellular base transceiver station (BTS) clocks, which alleviates the need for a base receiver. Experimental data is described herein that the beat frequency stability of cellular BTSs approaches that of atomic standards, which could be exploited for precise navigation with cellular carrier phase measurements. Results are provided for experiments showing a single UAV navigating with submeter level accuracy for more than 5 minutes, with one experiment showing 36.61 cm position RMSE over a UAV trajectory of 1.72 km and another showing 88.58 cm position RMSE over a UAV trajectory of 3.07 km.

FIG. 1B is a graphical representation of a system for navigation according to one or more embodiments. System 150 includes rover 151 and base station 161 which can receive signals generated by a communication system including a plurality of BTSs BTSs 155₁₋ₙ may include antenna elements configured to transmit signals that may be detected by rover 151 and base 161. Rover 151 may be configured similar to receiver 105 of FIG. 1A and base 161 may be configured similar to optional base station 111. Rover 151 and base station 161 may each be configured to receive downlink transmissions from BTSs 155₁₋ₙ, such as cellular communication signals. Rover 151 and base 161 may each communication with a central database 165 to exchange observables. Rover 151 may also communicate with base 161. According to embodiments, processes and configurations are provided for rover 151 and base 161 to use at least one of a differential and non-differential framework. As used herein, navigation may relate to using communication signals, which are non-positioning signals, to aid in navigation and/or one or more navigation operations. In addition, navigation functions described herein may be applied to one or more autonomous vehicles, such as autonomous vehicles and autonomous aerial vehicles.

Configurations of FIGS. 1A-1B may utilize a cellular carrier phase observable model. In cellular systems, several known signals are transmitted for synchronization or channel estimation purposes. By way of example, CDMA systems transmit a pilot signal including pseudorandom noise (PRN) sequences, known as the short code, which is modulated by a carrier signal and broadcast by each BTS for synchronization purposes. Therefore, by knowing the shortcode, the receiver may measure the code phase of the pilot signal as well as its carrier phase; hence, forming a pseudorange measurement to each BTS transmitting the pilot signal. In LTE, two synchronization signals (primary synchronization signal (PSS) and secondary synchronization signal (SSS)) are broadcast by each BTS, referred to evolved node B (eNodeB) in LTE systems. In addition to the PSS and SSS, a reference signal known as the cell-specific reference signal (CRS), is transmitted by each eNodeB for channel estimation purposes.

The PSS, SSS, and CRS may be exploited to draw carrier phase and pseudorange measurements on neighboring eNodeBs. In this disclosure, availability of code phase and Doppler frequency measurements of cellular CDMA and LTE signals is assumed (e.g., from navigation receivers. The continuous-time carrier phase observable can be obtained by integrating the Doppler measurement over time. The carrier phase (expressed in cycles) made by the i-th receiver on the n-th SOP is given by

ϕₙ⁽ⁱ⁾(t)=ϕₙ⁽ⁱ⁾(t₀)+∫ₜ_{₀}^{t}f_{D}_{ₙ}^{(t)}(r)dr,n=1, . . . , N, (1)

where f_{D}_{ₙ}⁽ⁱ⁾ is the Doppler measurement made by the ith receiver on the n-th cellular SOP, ϕₙ⁽ⁱ⁾(t₀)is the initial carrier phase, and N is the total number of SOPs. In (1), i denotes either the base (B) or the rover UAV (U). Assuming a constant Doppler during a subaccumulation period T, (1) can be discretized to yield

$${ϕ}_{n}^{( i )} ( {t}_{k} ) = {ϕ}_{n}^{( i )} ( {t}_{0} ) + {\sum }_{l = 0}^{k - 1} {f}_{{D}_{n}}^{( i )} ( {t}_{i} ) T , \qquad ( 2 )$$

where tₖ [symbol]
t₀+kT. In what follows, the time argument tₖ will be replaced by k for simplicity of notation. Note that the receiver will make noisy carrier phase measurements. Adding measurement noise to (2) and expressing the carrier phase observable in meters yields

$${z}_{n}^{( i )} ( k ) = λ {ϕ}_{n}^{( i )} + λ T {\sum }_{l = 0}^{k - 1} {f}_{{D}_{n}}^{( i )} ( l ) + {υ}_{n}^{( i )} ( k ) , \qquad ( 3 )$$

where λ is the wavelength of the carrier signal and vₙ⁽ⁱ⁾(k) is the measurement noise, which is modeled as a discrete-time zero-mean white Gaussian sequence with variance ┌σₙ⁽ⁱ⁾(k)┐², which can be shown for a coherent second-order phase lock loop (PLL) to be given by

$${[ {σ}_{n}^{( i )} ( k ) ]}^{2} = {λ}^{2} \frac{{B}_{i , PLL}}{C / {N}_{0 , n} ( k )} , \qquad ( 4 )$$

where B_{i,PLL} is the receiver's PLL noise equivalent bandwidth and C/N_{0,n}(k) is the cellular SOP's measured carrier-to noise ratio at time-step k. Note that a coherent PLL may be employed in CDMA and LTE navigation receivers since the cellular synchronization and reference signals do not carry any data. The carrier phase in (3) can be parameterized in terms of the receiver and cellular SOP states as

zₙ⁽ⁱ⁾(k)=∥rᵣ_{ᵢ}(k)−rₛ_{ₙ}∥₂+c[δtᵣ_{ᵢ}(k)−δtₛ_{ₙ}(k)]+λNₙ⁽ⁱ⁾+vₙ⁽ⁱ⁾(k), 5)

where rᵣ_{ᵢ} [symbol] [xᵣ_{ᵢ}, [symbol] rᵢ]^{T} is the receiver's position vector; rₛ_{ₙ} [symbol]
[xₛ_{ₙ}, [symbol] sₙ]^{T} is the cellular BTS's position vector; c is the speed of light; δtᵣᵢ and δtₛₙ are the receiver's and cellular BTS's clock biases, respectively; and Nₙ⁽ⁱ⁾ is the carrier phase ambiguity. Note that the difference between the UAV's altitude and the cellular BTSs' altitudes is typically negligible compared to the range between the UAV and the BTSs. Therefore, one may estimate the UAV's two-dimensional (2-D) position only, without introducing significant errors. The subsequent analysis may be readily extended to 3-D; however, the vertical position estimate will suffer from large uncertainties due to the poor vertical diversity of cellular SOPs. If the UAV's altitude estimate is explicitly desired, an altimeter can be readily used. As such, the proposed frameworks will consider the 2-D case

### Navigation With Sop Carrier Phase Differential Cellular Measurements

According to embodiments, frameworks for CD-cellular navigation can include at least two receivers in an environment having N cellular BTSs. The receivers may be assumed to be listening to the same BTSs, with the BTS locations being known. Referring to FIG. 1B, base 161 may be a first receiver, referred to as the base (B), is assumed to have knowledge of its own position state (e.g., a stationary receiver deployed at a surveyed location or a high-flying aerial vehicle with access to GNSS). Rover 151 may be a second receiver, referred to as the rover UAV (U), does not know its position and aims to navigate using the CD-cellular framework. Base 161 communicates its own position and carrier phase observables with the rover 151. FIG. 1B illustrates a base/rover framework.

FIG. 2 illustrates a process for navigation using communications signal observables from communications signals according to one or more embodiments. Process 200 may be employed by a device, such as receiver 105 or rover 151, to determine one or more of a communication signal observable, a position estimate, and observables to aid in navigation.

Process 200 may be initiated by a device (e.g., receiver 105, rover 151) receiving at least one communication signal at block 205. Communication signals, such as cellular communication signals, may be received from one or more base transceivers by a device. According to embodiments, the device is not required to be registered with a communication network. Embodiments provide operations that may be executed by a device to detect signals of opportunity and process one or more elements of the signal, such as a synchronization element to determine one or more observables. According to embodiments, one or more types of cellular communication signals may be employed/detected by process 200 including but not limited to one of a code division multiple access (CDMA) cellular communication signal including a pseudo random noise sequence (PRN) as the synchronization element and a long term evolution (LTE) cellular communication signal including a primary synchronization signal (PSS) or secondary synchronization signal (SSS) as the synchronization element. As used herein, synchronization elements of a detected cellular communication signal may be one or more repeating elements and/or characteristics of a communication format that may be leveraged to assess carrier phase. Embodiments provide a communication signal model and framework for determining one or more observables such as carrier phase.

At block 210, the device can determine a position estimate based on the communication signal. According to embodiments, determining the position estimate at block 210 includes determining a coarse estimate of device position based on a carrier phase determination using the synchronization element of the cellular communication element, and refining the coarse estimate of device position using a framework to determine the position estimate. An extended Kalman filter (EKF) operation may be performed by the device on the received communication signal to obtain the coarse estimate of device position and by using a vector model of device position and a known position reference.

a navigation solution when a base transmitter is not available to provide observables.

Block 210 may include one or more operations to allow for use and processing of communication signal data. According to embodiments, a position determination at block 210 may be a coarse position determined using an extended Kalman filter (EKF) operation. The position estimate may be determined a coarse estimate of device position based on a carrier phase determination using the synchronization element of the cellular communication element. Block 210 may also include refining the coarse estimate of device position using a framework to determine the position estimate wherein a weighted nonlinear least squares estimator is applied to a model of device position for a plurality of time intervals. As discussed below, a batch solution may be determined obtained to fix at least one integer ambiguity.

According to embodiments, a differential framework is used to determine position of the device. As such, refining the coarse estimate includes a double differencing operation to obtain a batch solution to fix at least one integer ambiguity. The differential framework can determine position estimates using a base station position and a base station carrier phase measurement received from a base station (e.g., measurements and data from another deice receiving communications signals from the same base transceiver station). Accordingly, process 200 may optionally include receiving base data at block 220. Base data 220 may include data from a base receiver to be used in a differential framework. Base data 200 may be optional in embodiments as process 200 may operate in a non-differential framework. The differential framework determines the position estimate using a batch weighted non-linear least squares estimator to estimate position based on estimated integer ambiguities for a plurality of time intervals. According to embodiments, the batch weighted non-linear least squares (BWNLS) estimator uses a collection of carrier phase measurements from a plurality of time steps, and wherein the batch weighted non-linear least squares estimator is initialized with the coarse estimate of device position. In one embodiment, an upper bound of position error is determined in process 200 and utilized by the device to determine the position estimate.

According to other embodiments, a non-differential framework is used to determine position of the device. As discussed herein, a non-differential framework may provide a solution for determining observables when an initial position of a device is known. In additional, base data observables from block 220 may not be required in a non-differential framework. In one embodiment, the framework to determine the position estimate is a non-differential framework that includes using a known position of the device and weighted non-linear least squares estimator to estimate position based on clock cluster biases.

At block 215, the device may control navigation based on a determined position and/or position estimates. navigation using the position estimate and at least one of a differential and non-differential framework to determine device position for a plurality of time intervals. Navigation at block 215 may be in the absence and/or without the needs of a global positioning receiver. In addition, navigation at block may be based on one or more determined position estimates at block 210 for one or more time intervals.

FIG. 3 depicts a device configuration according to one or more embodiments. Device 300 may relate to a receiver or components of a rover configured to receive cellular communication signals. Device 300 may be configured to perform a CD-cellular navigation strategy. According to one embodiment, device 300 includes controller 305, communications module 310, and memory 315. Device 300 may optionally include an input/output module 320.

Controller 305 may relate to a processor or control device configured to execute one or more operations stored in memory 310, such as determination of a position estimate, extended Kalman Filtering, and resolution of integer ambiguities. Controller 305 may be coupled to memory 315 and communications module 310. Communications module 310 may be configured to receive one or more communication signals from one or more base stations. Communications module 310 may also be configured to receiver observables from one or more base transmitters. In certain embodiments communications module 310 may be configured to include one or more software defined radio elements to acquire and track transmitted signals. Position determinations and/or observables may be used to output navigation commands or operate device 300 by way of optional input/output module 320. Device 300 and controller 305 may be configured to perform one or more operations described herein including processes 200 of FIG. 2 and process 400 of FIG. 4.

### CD-Cellular Measurement Model

Navigation by embodiments may include estimation of rover position. According to embodiments, position estimation may be performed by double-differencing measurements using determinations for a rover and using measurements received from a base station. Frameworks as described herein may use a carrier phase differential (CD)-cellular measurement model for received signals. Navigation embodiments can estimate a rover's position by double-differencing the carrier phase measurements, and for example, carrier phase measurements described in equation (5). By way of example, measurements to a first SOP be taken as references to form the single difference z_{n,1}⁽ⁱ⁾(k)

[symbol]

zₙ⁽ⁱ⁾(k)−z₁⁽ⁱ⁾(k), for n=2, . . . , N. Subsequently, the double difference between U (e.g., rover) and B (e.g., base station) may be defined as

z_{n,1}^{(U,B)}(k) [symbol] z_{n,1}^{(U)}(k)−z_{n,1}^{(B)}(k) +∥rᵣ_{_{B}}(k)−rₛ_{ₙ}∥−∥rᵣ_{_{B}}(k)−rₛ_{₁}∥ [symbol] h_{n,1}^{(U)}(k)+λN_{n,1}^{(U,B)}+v_{n,1}^{(U,B)}(k), (6)

where n=2, .. . , N, h_{n,1}^{(U)}(k) [symbol]
∥rᵣᵤ(k)−rₛ_{ₙ}∥−∥rᵣᵤ(k)−rₛ_{₁}∥, N_{n,1}^{(U,B)} [symbol]
Nₙ^{(u)}−Nₙ^{(B)}−N₁^{(U)}+N₁^{(B)}, and v_{n,1}^{(U,B)}(k) [symbol]
vₙ^{(U)}(k)−vₙ^{(B)}(k)−v₁^{(U)}(k)+v₁^{(B)}(k).

In vector form the measurement model (6) becomes

z_{U,B}(k) [symbol] h[rᵣᵤ(k)]+λN+v_{U,B}(k), (7)

where
z_{U,B}(k) [symbol]
   [z_{2,1}^{(U,B)}(k), . . . , z_{M,1}^{(U,B)}(k)]^{T}
h[rᵣᵤ(k)] [symbol] [h_{2,1}^{(U)}(k), . . . , h_{M,1}^{(U)}(k)]^{T}
N [symbol] [N_{2,1}^{(U,B)}, . . . , N_{M,1}^{(U,B)}]^{T}
v_{U,B}(k) [symbol]
   [v_{2,1}^{(U,B)}(k), . . . , v_{M,1}^{(U,B)}(k)]^{T},
   where v_{U,B}^{(k)} has a covariance R_{U,B}^{(k)}, which can be readily shown to be R_{U,B}(k)=R⁽¹⁾(k)+[[σ₁^{(b)}(k)]²+[σ₁^{(U)}(k)]²]Ξ,
   where

R⁽¹⁾(k) [symbol] diag [[σ₂^{(b)}(k)]²+[σ₂^{(U)}(k)]², . . . , [σ_{N}^{(B)}(k)]²+[σ_{N}^{(U)}(k)]²],

and Ξ is a matrix of ones. Note that the vector N is now a vector of N−1 integers and has to be solved for along with the rover UAV's position r_{rU}. The next subsections present a framework to obtain a navigation solution with CD-cellular measurements.

### Navigation Strategy

According to embodiments, a navigation strategy is employed by the UAV. To this end, assume CD-cellular measurements are given at k=0, 1, 2. It is desired that, with probability greater than 1−a, the 2-norm of the position error be less than a desired threshold ζ for all k≥kζ. Let δrrU(k) denote the position error at time-step k. Then, it is desired that

Pr[∥δrᵣᵤ(k)∥²≤ζ²]≥1−1,∀k≥k_{ζ}. (8)

For k<kζ, the UAV will use an EKF to produce a “rough” estimate of its position and the integer ambiguities. Measurements at k=0 and k=1 are used to initialize the EKF. Then, at k=kζ, a batch weighted nonlinear least squares (B-WNLS) estimator for all measurements from k=0 to kζ is used to obtain an estimate of the integer ambiguities that guarantees (8) for k≥kζ. The EKF solution is used to initialize the B-WNLS. For k>kζ, the UAV will solve for its position using zU,B(k) and the estimated ambiguities through a point solution weighted nonlinear least-squares (PSWNLS). The time-step kζ is determined on-the-fly by the UAV via the test developed in the remaining of this section.

FIG. 4 illustrates a graphical representation of a navigation framework according to one or more embodiments. Process 400 includes operations for determining coarse position estimates and resolving integer ambiguities. Process 400 may include initialization of an EKF model at block 405, estimation of position at block 410, solving for integer ambiguities at block 415 and estimation of position using estimated integer ambiguities at block 425. Process 400 may be performed by one or more devices described herein for acquisition of one or more observables from communications signals according to one or more embodiments.

### EKF Model and Initialization

The EKF model may be initialized by defining the vector

$${z}_{U , {B}_{ini}} = [ \begin{matrix}{z}_{U , B} ( 0 ) \\ {z}_{U , B} ( 1 )\end{matrix} ] = {h}_{ini} [ {x}_{EKF} ( 1 ) ] + {υ}_{U , {B}_{ini}} , \qquad ( 9 )$$

$${h}_{ini} [ {x}_{EKF} ( 1 ) ] {=}^{Δ} [ \begin{matrix}h [ {r}_{{r}_{U}} ( 1 ) - T {\dot{r}}_{{r}_{U}} ( 1 ) ] + λ N \\ h [ {r}_{{r}_{U}} ( 1 ) ] + λ N\end{matrix} ] ,$$

as the state vector to be estimated by the EKF, where \dot{r}_{rU}^{T} is the 2-D velocity vector of the UAV. The UAV's position and velocity states are assumed to evolve according to a velocity random walk model. Note that only the float solution of N is estimated in the EKF, i.e., the integer constraint is relaxed. The EKF will produce an estimate \hat{x}_{EKF}(k|j), i.e., an estimate of xEKF(k) using all measurements zU,B(k) up to time-step j≤k, along with an estimation error covariance P_{EKF}(k|j) [symbol] [symbol] ┌\hat{x}_{EKF}(k̅|j)\hat{x}_{EKF}^{T}(k|j) where \hat{x}_{EKF}(k|j) [symbol] x_{EKF}(k)−\hat{k}(k|j) is the estimation error. The UAV's random walk dynamics and the measurement model in (7) are used to derive the EKF time-update and measurement update equations.

EKF initialization at block 405 is discussed next.

Note that the measurement z_{U,B}_{ᵢₙᵢ}

[symbol]

[z_{U,B}^{T}(0), z_{U,B}^{T}(1)]^{T} may be parameterized as

$${z}_{U , {B}_{ini}} = [ \begin{matrix}{z}_{U , B} ( 0 ) \\ {z}_{U , B} ( 1 )\end{matrix} ] = {h}_{ini} [ {x}_{EKF} ( 1 ) ] + {v}_{U , {B}_{ini}} , \\ {h}_{ini} [ {x}_{EKF} ( 1 ) ] {=}^{△} [ \begin{matrix}h [ {r}_{{r}_{U}} ( 1 ) - T {\dot{r}}_{{r}_{U}} ( 1 ) ] + λ N \\ h [ {r}_{{r}_{U}} ( 1 ) ] + λ N\end{matrix} ] , \qquad ( 9 )$$

where T is the sampling time and v_{U,B}_{ᵢₙᵢ} [symbol]
[v_{U,B}^{T}(0), v_{U,B}^{T}(1]^{T} is the overall initial measurement noise, which is modeled as a zero-mean Gaussian random vector with covariance Rini=diag [RU,B(0),RU,B(1)]. The measurement equation in (9) can be solved using a weighted nonlinear least-squares (WNLS) estimator to yield an estimate of xEKF(1), denoted \hat{x}EKF,ini, and an associated estimation error covariance, denoted PEKF,ini. Finally, the EKF initial estimate and estimation error covariance are initialized according to \hat{x}_{EKF}(1|1)≡\hat{x}_{EKF,ini}, P_{EKF}(1|1)≡P_{EKF,ini}.

### B-WNLS Solution

When k=kζ, the B-WNLS estimate of the UAV's position and the integer ambiguities is computed. Define the collection of carrier phase measurements from time-step 0 to kζ as z_{U,B}^{kζ} [symbol] [z_{U,B}^{T}(0), . . . , z_{U,b}^{T}(k_{ζ}]^{T}

which can be expressed as

$${z}_{U , B}^{{k}_{ζ}} = h [ {r}_{{r}_{U}}^{{k}_{ζ}} ] + λ {\overline{I}}^{{k}_{ζ}} N + {v}_{U , B}^{{k}_{ζ}} , \\ {r}_{{r}_{U}}^{{k}_{ζ}} {=}^{△} [ \begin{matrix}{r}_{{r}_{U}} ( 0 ) \\ ⋮ \\ {r}_{{r}_{U}} ( {k}_{ζ} )\end{matrix} ] , {v}_{U , B}^{{k}_{ζ}} {=}^{△} [ \begin{matrix}{v}_{U , B} ( 0 ) \\ ⋮ \\ {v}_{U , B} ( {k}_{ζ} )\end{matrix} ] , \\ h [ {r}_{{r}_{U}}^{{k}_{ζ}} ] {=}^{△} [ \begin{matrix}h [ {r}_{{r}_{U}} ( 0 ) ] \\ ⋮ \\ h [ {r}_{{r}_{U}} ( {k}_{ζ} ) ]\end{matrix} ] , {\overline{I}}^{{k}_{ζ}} k {=}^{△} [ \begin{matrix}{I}_{( N - 1 ) \times ( N - 1 )} \\ ⋮ \\ {I}_{( N - 1 ) \times ( N - 1 )}\end{matrix} ] , \qquad ( 10 )$$

where v_{U,B}^{kζ}is the overall carrier phase measurement noise with covariance R_{U,B}^{k}^{_{ζ}} [symbol]
diag [R_{U,B}(0), . . . , R_{U,B}(k_{ζ})].

Let x_{B-WNLS}^{k}^{_{ζ}} [symbol] [(rᵣ_{_{U}}^{k}^{_{ζ}})^{T},N^{T}]^{T} denote the parameters to be estimated. A B-WNLS estimator with weight matrix (R_{U,B}^{k}^{_{ζ}})⁻¹ is used to obtain an estimate \hat{x}_{B-WNLS}^{k}^{_{ζ}}

[symbol]

[(\hat{r}_{R}_{_{U}}^{k}^{_{ζ}})^{T}, (\hat{N}^{k}^{_{ζ}})^{T}]^{T} of x_{B-WNLS}^{k} and an associated estimation error covariance P_{B-WNLS}^{k}^{_{ζ}}, given by

$${P}_{B - WNLS}^{{k}_{ζ}} [ \begin{matrix}{P}_{{r}_{U}}^{{k}_{ζ}} & {P}_{{r}_{U} , N}^{{k}_{ζ}} \\ {P}_{{r}_{U} , N}^{{{k}_{ζ}}^{T}} & {P}_{N}^{{k}_{ζ}}\end{matrix} ] .$$

Note the dependency of \hat{N}^{k}^{_{ζ}} on k_{ζ}.

Next, a LAMBDA method may be used to fix the integer ambiguities from the float solution and \hat{N}^{k}^{_{ζ}} and P_{N}^{k}^{_{ζ}}. \hat{N}^{k}^{_{ζ}} denotes the fixed integer ambiguities; then, the UAV's fixed position estimates \hat{r}_{rU}^{k} are obtained according to \hat{r}_{rU}^{k}^{_{ζ}}=\hat{r}_{rU,N}^{k}^{_{ζ}}P^{k}^{_{ζ}}⁻¹_{N} (\hat{N}^{k}^{_{ζ}}−\hat{N}^{k}^{_{ζ}})

Note that the B-WNLS solution is initialized with the EKF estimates of the UAV positions and ambiguities.

### PS-WLNS

Once the integer ambiguities are determined, the carrier phase measurements at time-step k≥kζ are used to determine the point solution \hat{r}_{rU}(k) and an associated estimation error covariance P_{rU}(k) using a WNLS, i.e., the estimate of r_{rU}(k) using z_{U,B}(k) and N̅^{k}^{_{ζ}} and through a WNLS. To this end, define the integer ambiguity estimation error as N̅^{k}^{_{ζ}} [symbol] N−N̅^{k}^{_{ζ}}. Hence, the carrier phase measurement vector for k≥kζ can be parameterized by

z_{U,B}(k) [symbol] h[r_{rU}(k)]+λN̅^{k}^{_{ζ}}+λN̅^{k}+v_{U,B}(k). (11)

The difference between (7) and (11) is that now an estimate of N is known to the UAV, and it can therefore estimate its position vector instantaneously using zU,B(k). However, λN̅^{k}^{_{ζ}} is now introduced as an additional measurement error, which can be modeled as a zero-mean random vector with covariance P_{N}^{k}_{ζ}. The weight matrix in the PS-WNLS is chosen to be

Σ⁻¹(k) [symbol] [λ²P_{N}^{k}^{_{ζ}}+R_{U,B}(k)]⁻¹. (12)

In the following sections, kζ is determined to satisfy ∀k≥k_{ζ}. To this end, the position error is first upper bounded and a test on k is derived to determine when (8) will hold.

### Position Error Upper Bound

In what follows, it is assumed that the contribution of v_{U,B}(k) to the estimation error is insignificant compared to N̅^{k}^{_{ζ}}. The position error due to N̅^{k}^{_{ζ}} can be approximated by

δr_{rU}(k)=λ[G̅^{T}(k)Σ⁻¹(k)G̅(k)]⁻¹G̅^{T}(k)Σ⁻¹(k)N̅^{k}^{_{ζ}}, (13)

where

$$\tilde{G} ( k ) = [ \begin{matrix}\frac{\text{?} {r}_{{r}_{U}} ( k ) - r \text{?}}{‖ \text{?} {r}_{{r}_{U}} ( k ) - r \text{?} ‖} - \frac{\text{?} {r}_{{r}_{U}} ( k ) - r \text{?}}{‖ \text{?} {r}_{{r}_{U}} ( k ) - r \text{?} ‖} \\ ⋮ \\ \frac{\text{?} {r}_{{r}_{U}} ( k ) - r \text{?}}{‖ \text{?} {r}_{{r}_{U}} ( k ) - r \text{?} ‖} - \frac{\text{?} {r}_{{r}_{U}} ( k ) - r \text{?}}{‖ \text{?} {r}_{{r}_{U}} ( k ) - r \text{?} ‖}\end{matrix} ] .$$

$$\text{?} \text{indicates text missing or illegible when filed}$$

The estimation error covariance associated with the position estimate is expressed as P_{rU}(k)=[G̅^{T}(k)Σ⁻¹(k)G̅(k)]⁻¹

In what follows, the time argument will be omitted for compactness of notation. Let

$$\sum \text{?}$$

$$\text{?} \text{indicates text missing or illegible when filed}$$

denote a square root of Σ. Using the submultiplicative property of the 2-norm, it can be shown from (13) that

$${‖ δ {r}_{{r}_{U}} ‖}^{2} \leq {λ}^{2} {‖ {[ {\tilde{G}}^{T} {\sum }^{- 1} \tilde{G} ]}^{- 1} {\tilde{G}}^{T} {\sum }^{- \frac{1}{2}} ‖}^{2} {‖ {\sum }^{- \frac{1}{2}} {\tilde{N}}^{{k}_{ζ}} ‖}^{2}$$

Using the relationship between the 2-norm, singular values, and eigenvalues of a matrix, ∥δr_{rU}∥² can be further bounded according to

$${‖ δ {r}_{{r}_{U}} ‖}^{2} \leq {λ}^{2} {λ}_{max} ( {P}_{{r}_{U}} ) {‖ {\sum }^{- \frac{1}{2}} {\tilde{N}}^{{k}_{ζ}} ‖}^{2} ,$$

where λₘₐₓ(·) and λₘᵢₙ(·) denote the largest and smallest eigenvalues of a matrix, respectively. Note that

$$\begin{matrix}{P}_{{r}_{U}} ⪯ {λ}^{2} {λ}_{max} ( \sum ) {( {\tilde{G}}^{T} \tilde{G} )}^{- 1} \\ ⪯ {λ}^{2} {λ}_{max} ( \sum ) {\underbrace{trace [ {( {\tilde{G}}^{T} \tilde{G} )}^{- 1} ]}}_{{=}^{△} {HDOP}^{2}} {I}_{2 \times 2}\end{matrix} .$$

where the horizontal dilution of precision (HDOP) depends on the current geometry between the UAV and the cellular BTSs. With probability β, the HDOP is upper bounded according to Pr[HDOP≤HDOPₘₐₓ]=β,
where HDOPₘₐₓ can be calculated in advance from the known cellular BTS using stochastic geometry models, as discussed in the next subsection. Subsequently, max (PrU) can be bounded according to λₘₐₓ(P_{rU})≤λ²λₘₐₓ(Σ)HDOPₘₐₓ²,
which in turn implies that with a probability greater than β, the following holds

$${‖ δ {r}_{{r}_{U}} ‖}^{2} \leq {λ}^{2} {λ}_{max} ( \sum ) {HDOP}_{max}^{2} {‖ {\sum }^{- \frac{1}{2}} {\tilde{N}}^{{k}_{ζ}} ‖}^{2} .$$

### Determination of HDOPₘₐₓ

In order to determine the distribution of HDOP and hence HDOPₘₐₓ, stochastic geometry is used to model the relative geometry between the UAV and BTSs. Specifically, the BTS positions are modeled as a binomial point process (BPP) and the total number of hearable BTSs is assumed to be known. The BTS position distribution is parameterized by the minimum and maximum hearable distance to a BTS, denoted by dₘᵢₙ and dₘₐₓ, respectively. However, the HDOP can be parameterized by the bearing angles only; hence, the dependency on dₘᵢₙ and dₘₐₓ is eliminated. Then, several realizations of the BTS bearing angles are realized for a given value of N and the empirical cumulative density function (cdf) of the HDOP is characterized. Finally, the value HDOPₘₐₓ is identified from the empirical cdf for a desired β.

FIG. 5A illustrates a graphical representation of a UAV and base transmitter stations according to one or more embodiments. FIG. 5A also illustrates a realization of the BPP for N=15 (dmin=50m and dmax=5000 m). In the Voroni diagram 500 in FIG. 5A, asterisks 501 indicate BTS locations and disc 502 at the origin indicates a UAV location. Shaded area 503 is the region defined between dₘᵢₙ and dₘₐₓ.

FIG. 5B illustrates a graphical representation of horizontal dilution of precision according to one or more embodiments. FIG. 5B shows graph 505 plotting HDOPₘₐₓ for various N and β obtained from 105 BPP realizations. HDOPₘₐₓ that satisfies the Pr[HDOP≤HDOPₘₐₓ]=β for various N and β values. The empirical cdf of the HDOP was calculated from 10⁵ BPP realizations.

### Integer Ambiguity Error Upper Bound

With a probability greater than 1−p, N̅^{k}^{_{ζ}} will be within the confidence region defined as

$${( {\tilde{N}}^{{k}_{ξ}} )}^{⊤} {P}_{N}^{{k}_{ξ} - 1} {\tilde{N}}^{{k}_{ξ}} \leq γ ( p ) , \qquad ( 14 )$$

where γ(p) [symbol] f_{v2 N-1}⁻¹(1−p) and f_{v2,M}⁻¹(·) is the inverse cdf of a chi-square distributed random variable with M degrees of freedom. By defining

$${\tilde{P}}_{N}^{{k}_{ζ}} {=}^{△} {\sum }^{- \frac{1}{2}} {P}_{N}^{{k}_{ζ}} {\sum }^{- \frac{1}{2}} ,$$

the inequality in (14) may be re-written as

$${( {\sum }^{- \frac{1}{2}} {\tilde{N}}^{{k}_{ζ}} )}^{T} {( {\tilde{P}}_{N}^{{k}_{ζ}} )}^{- 1} {\sum }^{- \frac{1}{2}} {\tilde{N}}^{{k}_{ζ}} \leq γ ( p ) . \qquad ( 15 )$$

Note that (15) implies the inequality

$$Pr [ {‖ {\sum }^{- \frac{1}{2}} {\tilde{N}}^{{k}_{ζ}} ‖}^{2} \leq {λ}_{max} ( {\tilde{P}}_{N}^{{k}_{ζ}} ) γ ( p ) ] \geq 1 - p . \qquad ( 16 )$$

### Eigenvalue Test for Batch Size Determination

Assuming that the HDOP and N̅ are independent, the following inequality holds Pr[∥δr_{rU}∥²≤λ²ₘₐₓ(Σ)HDOPₘₐₓ²λₘₐₓ(P̅_{N}^{k}^{_{ζ}})γ(p)]≥γ)1−p).

Recall that (8) is desired; therefore, satisfying

λ²λₘₐₓ(Σ)HDOPₘₐₓ²λₘₐₓ(P̅_{N}^{k}^{_{ζ}})γ(p)≤ζ²⇒λₘᵢₙ((P̅_{N}^{k}^{_{ζ}})⁻¹)≥g(ζ,p), (17)

where

$$g ( ζ , p ) {=}^{△} ( \frac{1}{{ζ}^{2}} ) [ {λ}^{2} {λ}_{max} ( \sum ) {HDOP}_{max}^{2} γ ( p ) ]$$

and p=1−(1−a)/γ achieves (8). Note that the inequality in (17) is in the form of a test that can be performed after each measurement is added to the batch filter.

According to embodiments, it may be easier to compute (P̅_{N}^{k}^{_{ζ}})⁻¹ rather than P̅_{N}^{k}^{_{ζ}}without having to solve the batch WNLS; hence, the test is λₘᵢₙ ((P̅_{N}^{k}^{_{ζ}})⁻¹). It can be shown that the inversion of 2×2 matrices only is needed to compute (P̅_{N}^{k}^{_{ζ}})⁻¹

### Navigation With Non-Differential SOP Carrier Phase Measurements: Single UAV

The base/rover framework according to embodiments may require the presence of a base and a communication channel between the base and the rover. However, if communication is lost or if the base is compromised, the navigating UAV cannot rely on CD cellular measurements anymore. This section discusses a non-differential cellular carrier phase navigation framework that is employable on a single UAV in the case that CD-cellular measurements are not available. Note that since what follows only pertains to non-differential, single-UAV navigation, the UAV index i will be dropped for simplicity of notation.

The terms

$$c [ δ {t}_{r} ( k ) - δ {t}_{{s}_{n}} ( k ) + \frac{λ}{c} {N}_{n} ]$$

are combined into one term defined as

$$c δ {t}_{n} ( k ) {=}^{△} c [ δ {t}_{r} ( k ) - δ {t}_{{s}_{n}} ( k ) + \frac{λ}{c} {N}_{n} ] .$$

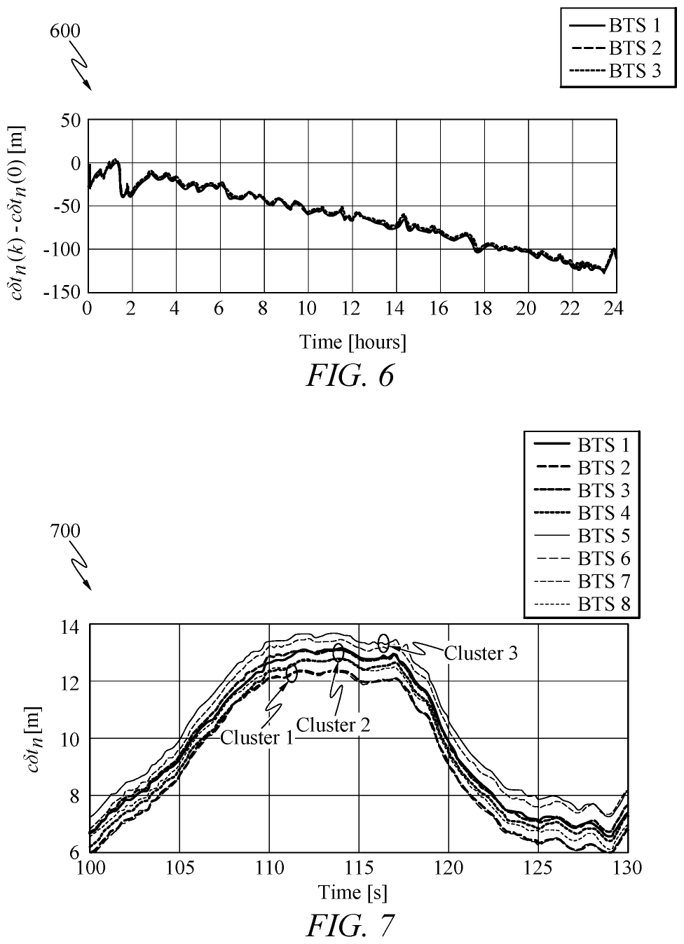

Cellular BTSs possess tighter carrier frequency synchronization then time (code phase) synchronization (the code phase synchronization requirement as per the cellular protocol is to be within 3 μs). Therefore, the resulting clock biases in the carrier phase estimates will be very similar, up to an initial bias, as shown in FIG. 6. Consequently, relative frequency stability may be used to eliminate parameters that need to be estimated. Moreover, this allows one to use a static estimator (e.g., a WNLS) to estimate the position of the UAV. To achieve this, in what follows, the carrier phase measurement is first re-parameterized and a WNLS estimation framework is subsequently developed.

FIG. 6 illustrates a graphical representation of carrier phase data 600 according to one or more embodiments. Carrier phase data 600 presents experimental data showing cδtₙ(k)-cδtₙ(0) obtained from carrier phase measurements over 24 hours for three neighboring BTSs. It can be seen that the clock biases in the carrier phase measurement are very similar, up to an initial bias cδtₙ(0) which has been removed.

Carrier Phase Measurement Re-Parametrization

Embodiments also provide for re-parametrization of

cδtₙ(k) [symbol] cδtₙ(k)-cδtₙ(0)≡cδt(k)+cₙ(k), (18)

where cδt is a time-varying common bias term and cₙ is the deviation of cδtₙ(k)-cδtₙ from this common bias and is treated as measurement noise. Using (18), the carrier phase measurement (5) can be re-parameterized as

zₙ(k)=∥rᵣ(k)-rₛ_{ₙ}∥+cδt(k)+cδt₀_{ₙ}+ηₙ(k), (19)

where cδt₀_{ₙ} [symbol]
cδtₙ(0) aηₙ(k) [symbol]
cₙ(k)+vₙ(k) is the overall measurement noise. Note that cδt₀_{ₙ} can be obtained knowing the initial position and given the initial measurement zₙ(0) according to cδt₀_{ₙ}≈zₙ (0)-∥rᵣ(0)-rₛ_{ₙ}∥. This approximation ignores the contribution of the initial measurement noise. If the receiver is initially stationary for a period k₀T seconds, which is short enough such that δt(k)≈0 for k=1,. . . , k₀), then the first k₀ samples may be averaged to obtain a more accurate estimate of cδt₀_{ₙ}.

It is proposed that instead of lumping all N clock biases into one bias cδt to be estimated, several clusters of clocks get formed, each of size

$${N}_{l} ( i . e . , {\sum }_{l = 1}^{L} {N}_{l} = N ,$$

where L is the total number of clusters), and the clocks in each cluster are lumped into one bias cδtᵢ to be estimated. This gives finer granularity for the parametrization (18), since naturally, certain groups of cellular SOPs will be more synchronized with each other than with other groups (e.g., corresponding to the same network provider, transmission protocol, etc.). An illustrative experimental plot is shown in FIG. 7. Note that since the 2-D position vector of the UAV is being estimated along with L clock biases, the number of clusters L cannot exceed N−2, otherwise there would be more unknowns than measurements

FIG. 7 illustrates a graphical representation of experimental data according to one or more embodiments. Experimental data for cδtₙ(k) over 30 seconds for 8 BTSs. The clock biases have been visually clustered into three clusters as an illustrative example.

Without loss of generality, it assumed that the carrier phase measurements have been ordered such that the first N1 measurements were grouped into the first cluster, the second N2 measurements were grouped into the second cluster, and so on. Next, obtaining the navigation solution with a WNLS is discussed.

### Navigation Solution

Given N≥3 pseudoranges modeled according to (19) and L≤N−2 SOP clusters, the receiver may solve for its current position rr and the current set of common biases

cδt

[symbol]

cδt₁, . . . , cδt_{L}^{T} using a WNLS estimator. The state to be estimated is defined by x [symbol]
[rᵣ^{T},cδt^{T}]^{T}. An estimate \hat{x} may be obtained using the iterated WNLS equations given by

\hat{x}⁽ⁱ⁺¹⁾(k)=\hat{x}ⁱ⁾(k)+(H^{T}R_{η}⁻¹H)⁻¹H^{T}R_{η}⁻¹δz(k), (20)

where
where δz(k) [symbol] [δz₁(k), . . . , δz_{N}(k)]^{T} and

$$δ {z}_{n} ( k ) {=}^{Δ} {z}_{n} ( k ) - [ ‖ {\hat{r}}_{r}^{( j )} ( k ) - {r}_{{s}_{n}} ‖ + c δ {t}_{{l}_{n}}^{( j )} ( k ) + c δ {t}_{{0}_{n}} ] ,$$

$${R}_{η} = diag [ {σ}_{1}^{2} + {σ}_{{ϵ}_{1}}^{{‖}_{2}} , … , {σ}_{N}^{2} + {σ}_{{ϵ}_{N}}^{{‖}_{2}} ]$$

is the measurement noise covariance where σ_{c}_{ₙ}² is discussed below, j is the WNLS iteration index, and H is the measurement Jacobian given by

$$H {=}^{Δ} [ G Γ ] , Γ {=}^{Δ} [ \begin{matrix}{1}_{{N}_{l}} & … & 0 \\ ⋮ & ⋱ & ⋮ \\ 0 & … & {1}_{{N}_{L}}\end{matrix} ] , \qquad ( 21 )$$

$$G {=}^{Δ} {[ \frac{{\hat{r}}_{r}^{( j )} - {r}_{{s}_{1}}}{‖ {\hat{r}}^{( j )} - {r}_{{s}_{1}} ‖} … \frac{{\hat{r}}_{r}^{( j )} - {r}_{{s}_{N}}}{‖ {\hat{r}}^{( j )} - {r}_{{s}_{N}} ‖} ]}^{⊤} , and \qquad ( 22 )$$

$${1}_{{N}_{l}} {=}^{Δ} {[ 1 , … , 1 ]}^{⊤} .$$

$$Note that {l}_{n} = \{ \begin{matrix}1 , & for n = 1 , … , {N}_{1} , \\ 2 , & for n = {N}_{1} + 1 , … , {\sum }_{l = 1}^{2} {N}_{l} , \\ ⋮ & ⋮ \\ L , & for n = {\sum }_{l = 1}^{L - 1} {N}_{l} + 1 , … , N .\end{matrix}$$

After convergence

$$( i . e . , {\hat{x}}^{( j + 1 )} ( k ) \approx \underline{{\hat{x}}^{( j )}} ( k ) )$$

the final estimate is obtained by setting \hat{x}(k)≡\hat{x}ⁱ⁺¹⁾(k). In the rest of the disclosure, it is assumed that H is always full column rank.

### Common Clock Bias Parametrization

Note that the clock bias clusters {cδtₗ}ᵢ₌₁^{L} are “virtual clock biases”, which are introduced to group SOPs whose carrier frequency is more synchronized than others. This would in turn yield more precise measurement models, reducing the estimation error. This subsection parameterizes cδt₁ as a function of cδtₙ. This parametrization is based on the following theorem.

Theorem IV.1. Consider N≥3 carrier phase measurements.

Assume that the contribution of the relative clock deviation cₙ is much larger than the carrier phase measurement noise vₙ and that cₙ are uncorrelated with identical variances σ² Then, the position error at any time instant δᵣ_{ᵣ}(k) due to relative clock deviations is independent of cδtₜ.

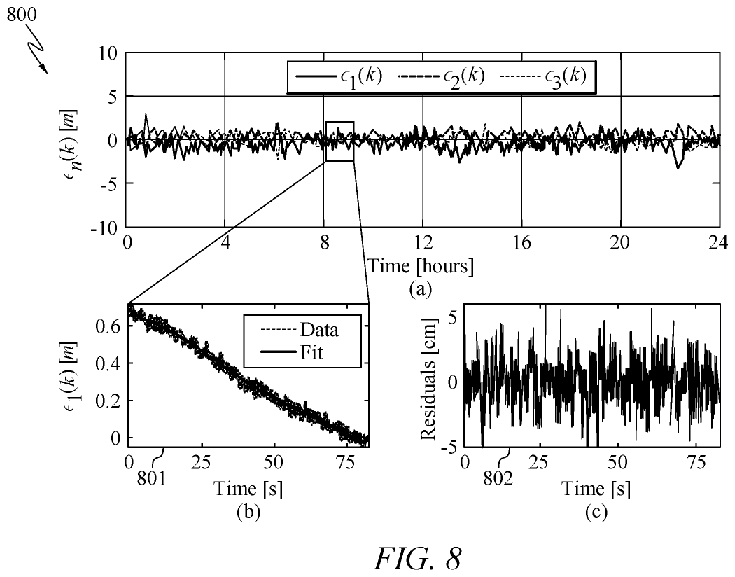

The assumption that the contribution of the relative clock deviation cₙ is much larger than the carrier phase measurement noise vₙ comes from experimental data, where ∥δ∥ was observed to be within 0.2 and 4 m, whereas σn was on the order of a few cm. To illustrate that, FIG. 8 shows the time history 800 of cₙ for the three BTSs shown in FIG. 6 over 24 hours, from which it is clearly seen that ∥ϵ∥ can be in the order of a few meters. Window 801 shows a 75-second portion of ϵ₁ around the eighth hour, as well as a polynomial fit. The residuals between the data and the polynomial fit are shown in window 802, whose standard deviation was calculated to be 1.85 cm. These residuals contain the effect of v₁(k) as well as w_{c}_{₁} (k); therefore, in this case, σₙ is upper bounded by 1.85 cm, which validates the assumption that the relative clock deviation ϵₙ is much larger than the carrier phase measurement noise vₙ.

From Theorem IV.1, it can be implied that while the position error is independent of cδtₜ, it depends on the clustering. Following the result in (29), the following parametrization is adopted

$$c δ {t}_{l} ( k ) ≡ \frac{1}{{N}_{l}} {\sum }_{i = 1}^{{N}_{l}} c \overline{δ} {t}_{{l}_{i}} ( k ) , {ϵ}_{n} ( k ) ≡ c \overline{δ} {t}_{n} ( k ) - c δ {t}_{l} ( k ) . \qquad ( 23 )$$

Note that the UAV can perform an exhaustive search over the different clustering possibilities to minimize its position error while it has access to GPS. The number of possible clusters is given by

$${N}_{clus} = {\sum }_{L = 1}^{N - 2} ( \begin{matrix}N \\ L\end{matrix} ) = {\sum }_{L = 1}^{N - {2}^{*}} \frac{N !}{L ! ( N - L ) !} .$$

It can be seen that this number becomes impractically large as N increases. A rule-of-thumb that significantly reduces Nnum is discussed below.

### Statistics of the Clock Deviations

Experiments for embodiments of the disclosure found that ϵₙ is appropriately modeled to evolve according to the autoregressive moving average (ARMA) model given by

$${ϵ}_{n} ( k + 1 ) = {\sum }_{i = 1}^{p} {ϕ}_{i} {ϵ}_{n} ( k - i + 1 ) + {\sum }_{i = 1}^{q} {ψ}_{i} {w}_{{ϵ}_{n}} ( k - i + 1 ) + {w}_{{ϵ}_{n}} ( k ) , \qquad ( 24 )$$

where P and {ϕᵢ}ᵢ₌₁^{p} are the order and the coefficients of the autoregressive (AR) part, respectively; order and the coefficients of the moving average (MA) part, respectively; and wQ is a white sequence. Identifying p and q and their corresponding coefficients can be readily obtained with standard system identification techniques [70], and it was found that p=q=6 was

usually enough to whiten w_{ϵdi n}.

Therefore, ϵₙ will also be a Gaussian sequence. Without loss of generality, it is assumed that ϵₙ(i-p)=0 for i=1, . . . , p. Subsequently,

[symbol]

[ϵₙ(k)]=0. The variance of ϵₙ (k) is discussed next. The ARMA process in (24) may be represented in state-space according to

ξₙ(k+1)=F_{ξn}ξₙ(k)+Γ_{ξn}w_{ϵn}(k) ϵₙ(k)=h_{ϵ}_{ₙ}^{T}ξₙ(k)

where ξₙ is the underlying dynamic AR process, F_{ξn} is its state transition matrix, Γ_{ξn} is the input matrix, and h_{ϵ}_{ₙ}^{T} is the output matrix. The eigenvalues of \dot{F}_{ϵn} were computed to be inside the unit circle, implying stability of ξₙ.The covariance of ξₙ denoted P_{ξn}, evolves according to P_{ξn}(k+1)=F_{ξn}P_{ξn}(k)F_{ξn}^{T}+Q_{ξn},
where

$${Q}_{{ξ}_{n}} {=}^{Δ} {σ}_{{w}_{ε}}^{2} {Γ}_{{ξ}_{n}} {Γ}_{{ξ}_{n}}^{⊤}$$

and the variance of the clock deviation ϵₙ at any given time-step is given by σ_{ϵ}_{ₙ}²k)=h_{ϵ}_{ₙ}^{T}P_{ξ}_{ₙ}(k)h_{ϵ}_{ₙ}.

Since ξₙ is stable, Pξn (k) will converge to a finite steady state convariance denoted P_{ξn}⁸⁸ given by the solution to the discrete-time matrix Lyapunov equation

P_{ξn},888=F_{ξn}P_{ξn}888F_{ξn}^{T}+Q_{ξn},

Subsequently, the steady-state variance of the clock deviation is given by σ_{ϵ}_{ₙ}²=h_{ϵ}_{ₙ}^{T}P_{ξn,88}h_{ϵn}.

Clustering of the Clock Biases

It was mentioned above that an exhaustive search may be performed to cluster the clock biases cδtₙ in order to minimize the position estimation error. This amounts to finding the matrix Γ that minimizes

$${J}_{p} ( Γ ) {=}^{Δ} {\sum }_{k = 1}^{{k}_{0}} {‖ δ {r}_{r} ( k ) ‖}^{2} = {\sum }_{k = 1}^{{k}_{0}} {‖ {[ {G}^{⊤} ( I - {Γ ( {Γ}^{⊤} Γ )}^{- 1} {Γ}^{⊤} ) G ]}^{- 1} {G}^{⊤} ( I - {Γ ( {Γ}^{⊤} Γ )}^{- 1} {Γ}^{⊤} ) ϵ ( k ) ‖}^{2} = {\sum }_{k = 1}^{{k}_{0}} {‖ {( {G}^{⊤} Ψ G )}^{- 1} {G}^{⊤} Ψ ϵ ( k ) ‖}^{2} ,$$

where Γ and Ψ are defined in (21) and (28), respectively. This optimization problem is non-convex and intractable. Instead of optimizing Jₚ(Γ), a tractable rule-of-thumb is provided next.
First, consider the modified cost function

$$\begin{matrix}J ( Γ ) {=}^{Δ} {‖ {( {G}^{⊤} Ψ G )}^{- 1} {G}^{⊤} Ψ ϵ ( {k}_{0} ) ‖}^{2} \\ = {‖ {( {G}^{⊤} ΨΨ G )}^{- 1} {G}^{⊤} ΨΨ ϵ ( {k}_{0} ) ‖}^{2} \leq \\ {‖ {( {G}_{Γ}^{⊤} {G}_{Γ} )}^{- 1} {G}_{Γ}^{⊤} ‖}^{2} {‖ Ψϵ ( {k}_{0} ) ‖}^{2} ,\end{matrix}$$

where Gᵣ [symbol] ΨG. Let the singular value decomposition (svd) of Gᵣ be Gᵣ=UΣᵣV^{T}, where U is an N×N unitary matrix, V is a 2×2 unitary matrix, and Σᵣ=[Σ9]¹, where Σ is a nonsingular 2×2 diagonal matrix containing the nonzero singular values of Gᵣ. It can be readily shown that

(Gᵣ^{T}Gᵣ)⁻¹Gᵣ^{T}=VΣ′U^{T}, (25)

where Σ′ [symbol] [Σ⁻¹0]^{T}. This implies that (25) is the svd of

$${( {G}_{Γ}^{⊤} {G}_{Γ} )}^{- 1} {G}_{Γ}^{⊤}$$

and its singular values are the inverses of the singular values of Gᵣ, yielding

$${‖ {( {G}_{Γ}^{⊤} {G}_{Γ} )}^{- 1} {G}_{Γ}^{⊤} ‖}^{2} = {[ {σ}_{max} ( {G}_{Γ} ) ]}^{2} = {[ \frac{1}{{σ}_{min} ( {G}_{Γ} )} ]}^{2} ,$$

where σₘₐₓ (·) and σₘᵢₙ (·) denote the maximum and minimum singular values of a matrix, respectively. Note that the singular values of Gᵣ are the square root of the eigenvalues of GT Gᵣ^{T}Gᵣ=G^{T}ΨG, G=GT G, and hence

$${‖ {( {G}_{Γ}^{⊤} {G}_{Γ} )}^{- 1} {G}_{Γ}^{⊤} ‖}^{2} = \frac{1}{{λ}_{min} ( {G}^{⊤} Ψ G )} = {λ}_{max} ( {P}_{x , y} ) ,$$

where λₘₐₓ (·)and λₘᵢₙ (·)denote the maximum and minimum eigenvalues of a matrix, respectively. Consequently, the cost J(Γ) may be bounded by

J(Γ)≤λₘₐₓ(P_{x,y})∥Ψ_{ϵ}(k₀∥², (26)

Next, two theorems are presented that will help derive the rule-of-thumb for clustering the clock biases. Theorem IV.2. Assume a clock bias clustering with L<N−2 clusters and denote J_{L} [symbol] ∥Ψϵ(k)∥²; 2. Then, there exists a clustering with L+1 clusters such that J_{L}≥J_{K+1}. From Theorem IV.2, it can be implied that ∥Ψϵ(k)∥² is minimized when L=N−2, i.e., the maximum number of clusters is used. This also implies that using more SOP clusters will decrease ∥Ψϵ*k₀)∥² in the upper bound expression of J(Γ) given in (26). Theorem IV.3. Consider N≥3 carrier phase measurements for estimating the receiver's position rᵣ and a clustering of L clock states cδt. Adding a carrier phase measurement from an additional cellular SOP while augmenting the clock state vector cδt by its corresponding additional clock state will neither change the position error nor the position error uncertainty.

From Theorem IV.3, it can be implied that it is required that Nₗ≥2 in order for cluster l to contribute in estimating the position state. Therefore, λₘₐₓ (P_{x,y}) can be made smaller by decreasing the number of clusters L. Combining the conclusions of Theorems IV.2 and IV.3 and referring to (26), there is a tradeoff between estimating more clock biases and uncertainty reduction: less bias for more uncertainty and vice versa. Subsequently, embodiments may operate using at least one cluster with Nₜ≥3 (to ensure observability) and N₁≥2 for the remaining clusters. This implies that

$$L \leq \frac{N - 3}{2} + 1 ,$$

which significantly reduces the number of possible clusters in the exhaustive search algorithm.

Experimental Results

This section presents experimental results demonstrating submeter-level UAV navigation results via the two frameworks developed in this disclosure: (1) CD-cellular with a base/rover and (2) non-differential single UAV with precise carrier phase measurements. As mentioned in above, only the 2-D positions of the UAVs are estimated as their altitudes may be obtained using other sensors (e.g., altimeter). In the following experiments, the altitudes of the UAVs were obtained from their on-board navigation systems. Moreover, the noise equivalent bandwidths of the receivers PLLs were set B_{U,PLL}=B_{B,PLL}=B_{PLL}=3 to Hz in all experiments.

### CD-Cellular UAV Navigation Results via the Base/Rover Framework

In this section, experimental results are presented demonstrating centimeter-level-accurate UAV navigation results using the CD-cellular framework according to embodiments of this disclosure. The measurement noise covariances were calculated according to (4). In order to demonstrate the CD-cellular framework, two Autel Robotics X-Star Premium UAVs were equipped each with an Ettus E312 universal software radio peripheral (USRP), a consumer-grade 800/1900 MHz cellular antenna, and a small consumer-grade GPS antenna to discipline the on-board oscillator. Note that one UAV acted as a base and the other as a navigating UAV. The receivers were tuned to a 882.75 MHz carrier frequency (i.e., λ=33.96 cm), which is a cellular CDMA channel allocated for the U.S. cellular provider Verizon Wireless. Samples of the received signals were stored for off-line post-processing. The cellular carrier phase measurements were given at a rate of 12.5 Hz, i.e., T=0.08 s. The ground-truth reference for each UAV trajectory was taken from its on-board integrated navigation system, which uses GPS, an inertial measurement unit (IMU), and other sensors. The navigating UAV's total traversed trajectory was 2.24 km, which was completed in 4 minutes. Over the course of the experiment, the receivers were listening to 9 BTSs, whose positions were mapped prior to the experiment. In the experiments, the UAV was flying approximately at the same altitude as the BTS antennas. Characteristics of experimental results may provide examples of embodiments described herein.

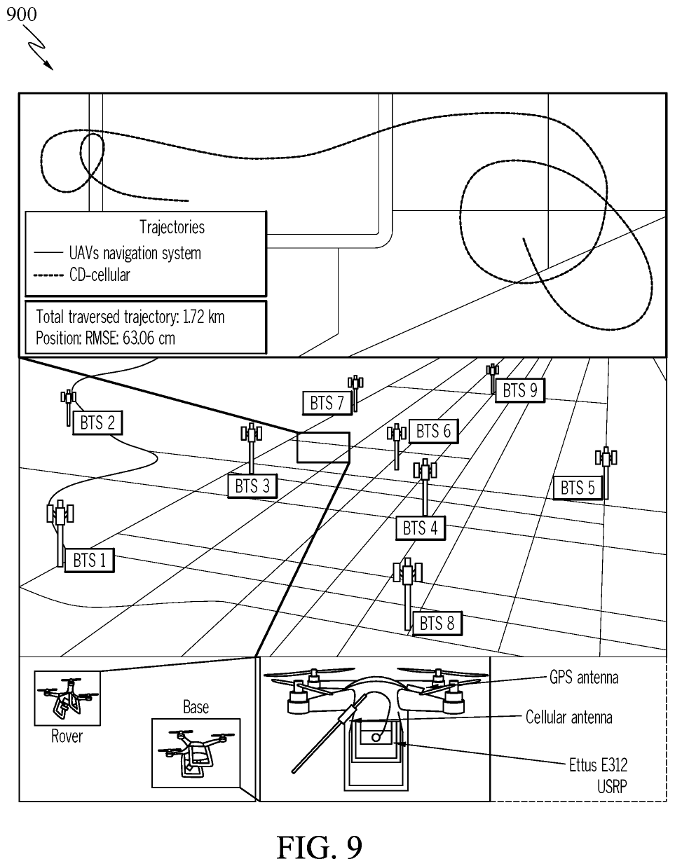

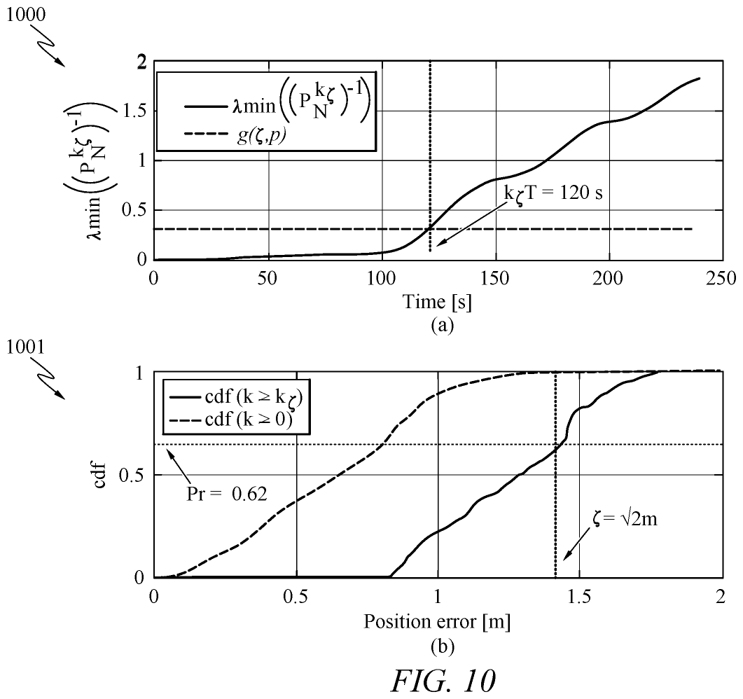

The CD-cellular measurements were used to estimate the navigating UAV's trajectory 900 via the base/UAV framework. The experimental setup, the cellular BTS layout, and the true trajectory (from the UAV's on-board integrated navigation system) and estimated trajectory (from the proposed CD-cellular framework) of the navigating UAV are shown in FIG. 9. True and estimate trajectories are also shown in FIG. 9. The probabilities β and α were set to 0.99 and 0.4, respectively, and the desired position error threshold was set to ζ=√2 m. For these parameters, kζT was found to be 120 s. The position RMSE for k<kζ was found to be 24.15 m (from the EKF), and 74.89 cm for k≥kζ (from the PS-WNLS, after resolving the integer ambiguities through the B-WNLS). The time history of λₘᵢₙ ((P̅_{N}^{k}^{_{ζ}})⁻¹) is shown as 1000 in FIG. 10 along with g(ζ,p) and the empirical cdf of the position RMSE for k≥0 and for k≥kζ, (after resolving the ambiguities through the B-WNLS) are shown as 1001 FIG. 10.

The position RMSE for each part of the trajectory are shown in Table I.

TABLE I
EXPERIMENTAL RESULTS FOR THE CD-
CELLULAR FRAMEWORK
(k_{ζ}T = 120 s)

| | | |
|---|---|---|
| k < k_{ζ} | k ≥ k_{ζ} | ∀k |

| Duration | 120 | s | 120 | s | 240 | s |
|---|---|---|---|---|---|---|
| Distance traveled | 0.96 | km | 1.28 | km | 2.24 | km |
| EKF RMSE | 24.15 | m | 3.95 | m | 14.53 | m |
| B-WNLS RMSE | 65.79 | cm | — | | — | |
| PS-WNLS RMSE | 65.79 | cm | 74.83 | cm | 70.48 | cm |

FIG. 10 illustrates representations of time and position error according to one or more embodiments. It can be seen from FIG. 10 that Pr┌∥δr_{rU}∥²≤ζ²┐=0.62≥1−α, where α was chosen to be 0.4. This demonstrates that the proposed navigation strategy achieves the bounded-error requirement.

Non-Differential Single UAV Navigation Results with Precise Cellular Carrier Phase Measurements

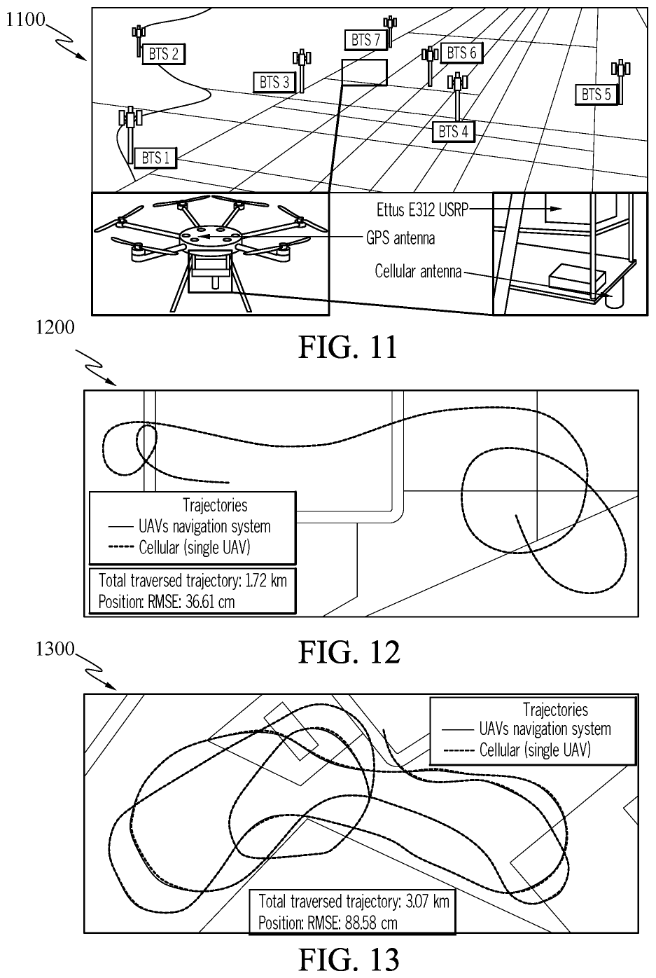

Two experiments were conducted at different times to demonstrate the non-differential single-UAV navigation framework described above. In the first experiment, the same setup described in Subsection V-A was used, except that the rover was navigating without the base and was employing the framework described herein. In the second experiment, a DJI Matrice 600 was equipped with the same hardware described in Subsection V-A and the onboard USRP was tuned to the same carrier frequency. The cellular carrier phase measurements were also given at a rate of 37.5 Hz, i.e., T=0.0267 ms. The ground-truth reference for the UAV trajectory was taken from its on-board navigation system, which also uses GPS, an IMU, and other sensors. The experimental setup and SOP BTS layout for the second experiment are shown as 1100 in FIG. 11. In both experiments, the UAVs had access to GPS for 10 seconds, then GPS was cut off. During the time where GPS was available, the cellular signals were used to cluster the cellular SOPs. FIG. 11 illustrates a navigation system and configuration according to one or more embodiments. The experimental setup and the SOP BTS layout for the second experiment demonstrating a single UAV navigating with precise non-differential cellular carrier phase measurements. FIG. 12 illustrates another navigation system and an experimental results demonstrating a single UAV navigating with precise non-differential cellular carrier phase measurements. The true and estimated trajectories are shown. FIG. 13 illustrates another navigation system and configuration, including a single UAV navigating with precise non-differential cellular carrier phase measurements.

In the first experiment, the UAV traversed a trajectory of 1.72 km, which was completed in 3 minutes. The receiver was listening to the same 9 CDMA BTSs shown in FIG. 9. The navigation results are shown as 1200 in FIG. 12. The optimal clustering was found to be C₁={BTS 1 , BTS 5, BTS 7, BTS 8}, C₂={BTS 2, BTS 3, BTS 6 }, and C₃={BTS 4, BTS 9}. The position RMSE was calculated to be 36.61 cm.

In the second experiment, the UAV traversed a trajectory of 3.07 km completed in 325 seconds. The receiver was listening to the 7 CDMA BTSs shown in FIG. 11. The navigation results are shown as 1300 in FIG. 13. The optimal clustering was found to be C1={BTS 1, BTS 2, BTS 3, BTS 4, BTS 6} and C2 ={BTS 5, BTS 7}. The position RMSE was calculated to be 88.58 cm.

Experimental results are summarized in Table II.

TABLE II
EXPERIMENTAL RESULTS

| | Experiment 1 | Experiment 2 |
|---|---|---|
| Framework | RMSE [cm] | RMSE [cm] |
| CD-Cellular with base/rover | 63.06 | — |
| Non-differential single UAV | 36.61 | 88.58 |

The following are takeaways and remarks from the CD-cellular and non-differential single-UAV experimental results presented above. First, it is important to note that all RMSEs were calculated with respect to the trajectory returned by the UAVs' on-board navigation system. Although these systems use multiple sensors for navigation, they are not equipped with high precision GPS receivers, e.g., RTK systems. Therefore, some errors are expected in what is considered to be “true” trajectories taken from the on-board sensors. The hovering horizontal precision of the UAVs are reported to be 2 meters for the X-Star Premium by Autel Robotics and 1.5 meters for the Matrice 600 by DJI.

Second, it can be noted that the CD-cellular with base/rover framework under-performed compared to the non-differential single-UAV framework. This can be due to: (1) poor synchronization between the base's and rover's measurements and (2) errors in the base's on-board navigation system's position estimates. It is important to note that the base was mobile during the experiment and the position returned by its on-board navigation system was used as ground-truth. Consequently, any errors in the GPS solution would have degraded the rover's estimate.

Third, the RMSEs reported in the non-differential single-UAV results are for optimal clustering. In the 10 seconds during which GPS was available, a search was performed to optimally cluster the clock biases using the rule-of-thumb. The search took less than 3 seconds in each case. The RMSEs without clustering (only one bias is estimated) are 48 cm and 97 cm for the first and second single-UAV experiments, respectively.

Fourth, the CD-cellular and non-differential single-UAV experiments showed that reliable navigation with cellular signals is possible when the proper models are used. Some of the experiments went over 5 minutes, indicating that the UAV could rely exclusively on cellular carrier phase measurements for sustained submeter-level accurate navigation.

Fifth, not only the UAV can navigate at submeter-level accuracy in the absence of GPS signals, but it can do so with performance guarantees. This is inherent to the formulation of the CD-cellular and the non-differential single-UAV frameworks. FIG. 10 is clearly satisfying (8) for β=0.99, α=0.4, and ζ=√2 m. Moreover, in the single-UAV experiments, optimal clustering resulted in approximately 24% and 9% reductions in the position RMSEs, respectively, over not clustering at all.

### CONCLUSION

The disclosure presents two frameworks for submeter-level accurate UAV navigation with cellular carrier phase measurements. The first framework, called CD-cellular framework, relies on a base receiver and a navigating receiver on-board a navigating UAV, also known as rover. Both receivers make carrier phase measurements to the same cellular SOPs to produce the cellular carrier phase double difference measurements, referred to as CD-cellular measurements. The main strategy behind the CD-cellular framework is to navigate in three stages. In the first stage, an EKF is employed to produce a coarse estimate of the UAV's position. In the second stage, which is determined by a test on the estimation error covariance, the UAV fixes the integer ambiguities in a batch solver. The test guarantees that the position error of the UAV will remain less than a pre-defined threshold with a desired probability after the batch solution is calculated. In the third stage, the UAV navigates with high precision with the CD-cellular measurements and fixed integer ambiguities. Experimental results demonstrated not only that the proposed framework guarantees a desired navigation performance, but it also showed a UAV navigation with 63.06 cm position RMSE over a trajectory of 1.72 km.

The second framework leverages the relative stability of cellular BTSs clocks. This stability also allows to parameterize the SOP clock biases by a common term plus some small deviations from the common term, which alleviates the need for a base. The clock deviations were subsequently modeled as a stochastic sequence using experimental data. Further analysis at those deviations revealed that they can be clustered to minimize the resulting position error. Next, performance bounds were established for this framework and a rule-of-thumb for clustering the clock deviations was established based on these bounds, which significantly reduced the complexity of the clustering step. Experimental results showed that a single UAV can navigate with submeter-level accuracy for more than 5 minutes using this framework, with one experiment showing 36.61 cm position RMSE over a trajectory of 1.72 km and another showing 88.58 cm position RMSE over a trajectory of 3.07 km.

While this disclosure has been particularly shown and described with references to exemplary embodiments thereof, it will be understood by those skilled in the art that various changes in form and details may be made therein without departing from the scope of the claimed embodiments.

What is claimed is:

1. A method for controlling navigation using cellular communication signals, the method comprising:
receiving, by a device, a cellular communication signal including a synchronization element;
determining, by the device, a position estimate for the device using the cellular communication signal, wherein determining the position estimate includes
determining a coarse estimate of device position based on a carrier phase determination using the synchronization element of the cellular communication element;
refining the coarse estimate of device position using a framework to determine the position estimate wherein a weighted nonlinear least squares estimator is applied to a model of device position for a plurality of time intervals; and
controlling, by the device, navigation using the position estimate.

2. The method of claim 1, wherein the communication signal is at least one of a code division multiple access (CDMA) cellular communication signal including a pseudo random noise sequence (PRN) as the synchronization element and a long term evolution (LTE) cellular communication signal including a primary synchronization signal (PSS) or secondary synchronization signal (SSS) as the synchronization element.

3. The method of claim 1, wherein an extended Kalman filter (EKF) operation is performed by the device on the received communication signal to obtain the coarse estimate of device position and by using a vector model of device position and a known position reference.

4. The method of claim 1, wherein refining the coarse estimate includes a double differencing operation to obtain a batch solution to fix at least one integer ambiguity.

5. The method of claim 1, wherein the framework to determine the position estimate is a differential framework that includes using a base station position and a base station carrier phase measurement received from a base station.

6. The method of claim 5, wherein the differential framework determines the position estimate using a batch weighted non-linear least squares estimator to estimate position based on estimated integer ambiguities for a plurality of time intervals.

7. The method of claim 6, wherein the batch weighted non-linear least squares estimator uses a collection of carrier phase measurements from a plurality of time steps, and wherein the batch weighted non-linear least squares estimator is initialized with the coarse estimate of device position.

8. The method of claim 1, wherein an upper bound of position error is determined and utilized by the device to determine the position estimate.

9. The method of claim 1, wherein the framework to determine the position estimate is a non-differential framework that includes using a known position of the device and weighted non-linear least squares estimator to estimate position based on clock cluster biases.

10. The method of claim 1, wherein navigation using the position estimate and at least one of a differential and non-differential framework to determine device position for a plurality of time intervals.

11. A device configured for controlling navigation using cellular communication signals, the device comprising:
a receiver configured to receive a cellular communication signal; and
a controller coupled to the receiver, the controller configured to
receive a cellular communication signal including a synchronization element;
determine a position estimate for the device using the cellular communication signal, wherein determining the position estimate includes
determine a coarse estimate of device position based on a carrier phase determination using the synchronization element of the cellular communication element;
refine the coarse estimate of device position using a framework to determine the position estimate wherein a weighted nonlinear least squares estimator is applied to a model of device position for a plurality of time intervals; and
control navigation using the position estimate.

12. The device of claim 11, wherein the communication signal is at least one of a code division multiple access (CDMA) cellular communication signal including a pseudo random noise sequence (PRN) as the synchronization element and a long term evolution (LTE) cellular communication signal including a primary synchronization signal (PSS) or secondary synchronization signal (SSS) as the synchronization element.

13. The device of claim 11, wherein an extended Kalman filter (EKF) operation is performed by the device on the received communication signal to obtain the coarse estimate of device position and by using a vector model of device position and a known position reference.

14. The device of claim 11, wherein refining the coarse estimate includes a double differencing operation to obtain a batch solution to fix at least one integer ambiguity.

15. The device of claim 11, wherein the framework to determine the position estimate is a differential framework that includes using a base station position and a base station carrier phase measurement received from a base station.

16. The device of claim 15, wherein the differential framework determines the position estimate using a batch weighted non-linear least squares estimator to estimate position based on estimated integer ambiguities for a plurality of time intervals.

17. The device of claim 16, wherein the batch weighted non-linear least squares estimator uses a collection of carrier phase measurements from a plurality of time steps, and wherein the batch weighted non-linear least squares estimator is initialized with the coarse estimate of device position.

18. The device of claim 11, wherein an upper bound of position error is determined and utilized by the device to determine the position estimate.

19. The device of claim 11, wherein the framework to determine the position estimate is a non-differential framework that includes using a known position of the device and weighted non-linear least squares estimator to estimate position based on clock cluster biases.

20. The device of claim 11, wherein navigation using the position estimate and at least one of a differential and non-differential framework to determine device position for a plurality of time intervals.
